(19) United States
(12) Patent Application Publication
(10) Pub. No.: US 2012/0147039 A1
(43) Pub. Date: Jun. 14, 2012

(54) TERMINAL AND METHOD FOR PROVIDING AUGMENTED REALITY

(75) Inventors: Sung Sik WANG, Anyang-si (KR); Yong Hoon CHO, Seoul (KR); Jong Hyun PARK, Seoul (KR); Joong Hwi SHIN, Namyangju-si (KR); Hwa Jeong LEE, Seoul (KR); In Cheol JEONG, Incheon (KR)

(73) Assignee: PANTECH CO., LTD., Seoul (KR)

(21) Appl. No.: 13/195,437

(22) Filed: Aug. 1, 2011

(30) Foreign Application Priority Data
Dec. 13, 2010 (KR) 10-2010-0127191

(51) Int. Cl. G09G 5/00

(52) U.S. Cl. 345/633

(57) ABSTRACT

A terminal to provide augmented reality includes a camera unit to capture a real-world view having a marker comprising a first region and a second region; a memory unit to store an object corresponding to the marker, first control information to control a first part of the object, and second control information to control a second part of the object; an object control unit to control the first part of the object based on the first control information if the first region is selected, and to control the second part of the object based on the second control information if the second region is selected; an image processing unit to synthesize the object with the real-world view into a synthesized view; and a display unit to display the synthesized view.

### CROSS-REFERENCE TO RELATED APPLICATION

This application claims priority from and the benefit under 35 U.S.C. §119(a) of Korean Patent Application No. 10-2010-0127191, filed on Dec. 13, 2010, which is incorporated by reference for all purposes as if fully set forth herein.

### BACKGROUND

1. Field

This disclosure relates to a terminal and a method for providing augmented reality (AR), and more particularly, to a terminal and a method for providing augmented reality that are capable of classifying a marker into multiple regions, mapping control information of an object to the multiple regions, and controlling the object according to the control information mapped to the corresponding region.

2. Discussion of the Background

In general, augmented reality refers to technology showing a physical, real-world environment of which elements are augmented by computer-generated sensory input. In the augmented reality, a technique may be used for combining the real world with a virtual world containing additional information to be shown as a single image. In order to synthesize the virtual world with the real world into a single image using the technique for implementing an augmented reality, a marker or an object such as a building in a real world is recognized.

If a real-world view including a marker is captured through a camera of a terminal, a pattern of the marker may be recognized. Then, an object corresponding to the marker based on the recognized pattern may be synthesized with the real-world view so as to be displayed on a display as a synthesized image.

### SUMMARY

Exemplary embodiments of the present invention provide a terminal and a method for providing augmented reality having a marker divided into multiple regions and control information mapped to the regions.

Additional features of the invention will be set forth in the description which follows, and in part will be apparent from the description, or may be learned by practice of the invention.

Exemplary embodiments of the present invention provide a terminal to provide augmented reality including a memory unit to store a marker including a first region and a second region, an object corresponding to the marker, and first control information mapped to a first part of the object; a camera unit to capture a real-world view including the marker; a first marker recognition unit to recognize the marker; a second marker recognition unit to recognize the first region; an object selection unit to retrieve the object and the first control information; an object control unit to control the first part of the object based on the first control information if the first region is selected; an image processing unit to synthesize the object with the real-world view into a synthesized view; and a display unit to display the synthesized view.

Exemplary embodiments of the present invention provide a method for providing augmented reality including storing a marker including a first region, an object corresponding to the marker, and first control information mapped to a first part of the object; determining whether the first region is selected; retrieving the first control information; controlling the first part of the object based on the first control information; synthesizing the object with the real-world view into a synthesized view; and displaying the synthesized view.

Exemplary embodiments of the present invention provide a terminal to provide augmented reality including a camera unit to capture a real-world view having a marker including a first region and a second region; a memory unit to store an object corresponding to the marker, first control information mapped to a first part of the object, and second control information mapped to a second part of the object; an object control unit to control the first part of the object based on the first control information if the first region is selected, and to control the second part of the object based on the second control information if the second region is selected; an image processing unit to synthesize the object with the real-world view into a synthesized view; and a display unit to display the synthesized view.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram showing a terminal to provide augmented reality according to an exemplary embodiment of the present invention.

FIG. 2 is a diagram illustrating a marker having four divided regions according to an exemplary embodiment of the present invention.

FIG. 3 is a diagram illustrating a marker having six divided regions according to an exemplary embodiment of the present invention.

FIG. 4 is a diagram illustrating a marker having eight divided regions according to an exemplary embodiment of the present invention.

FIG. 5 and FIG. 6 are diagrams illustrating objects associated with AR markers according to an exemplary embodiment of the present invention.

FIG. 7 is a flowchart illustrating a method for providing augmented reality using multiple regions of a marker according to an exemplary embodiment of the present invention.

FIG. 8 is a flowchart illustrating a method for providing augmented reality using multiple regions of a marker according to an exemplary embodiment of the present invention.

FIG. 9 is a flowchart illustrating a method for providing augmented reality using multiple regions of a marker according to an exemplary embodiment of the present invention.

FIG. 10 is a flowchart illustrating a method for providing augmented reality using multiple regions of a marker according to an exemplary embodiment of the present invention.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth herein. Rather, these exemplary embodiments are provided so that the present disclosure is thorough, and will fully convey the scope of the invention to those skilled in the art.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements. The shape, size and regions, and the like, of the drawing may be exaggerated for clarity.

Hereinafter, a terminal and a method for providing augmented reality according to exemplary embodiments will be described in more detail with reference to the accompanying drawings.

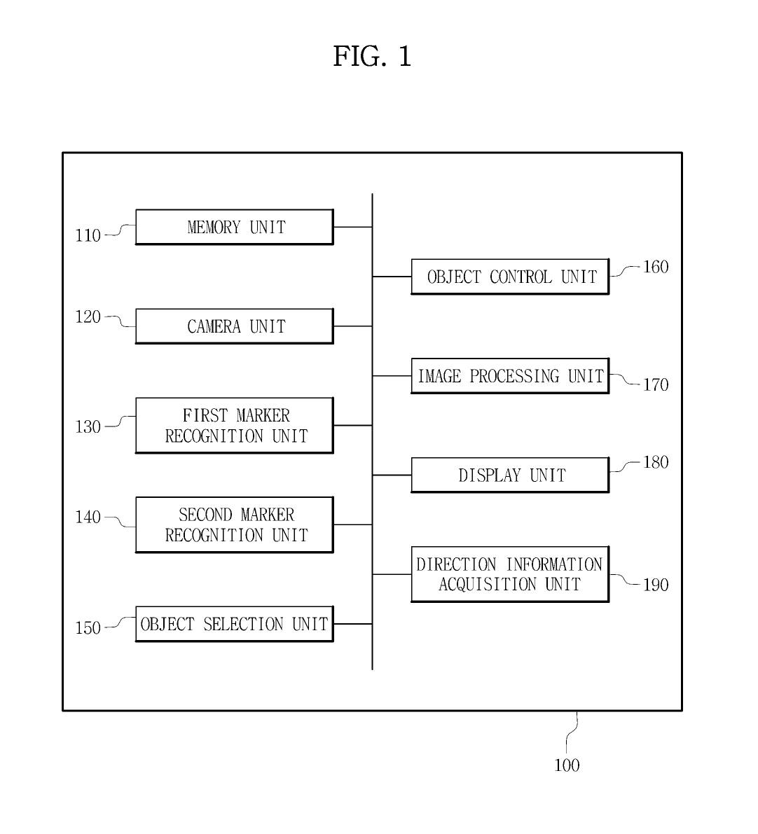

FIG. 1 is a diagram showing a terminal to provide augmented reality according to an exemplary embodiment of the present invention.

As shown in FIG. 1, the terminal 100 may include a memory unit 110, a camera unit 120, a first marker recognition unit 130, a second marker recognition unit 140, an object selection unit 150, an object control unit 160, an image processing unit 170, a display unit 180, and a direction information acquisition unit 190. The memory unit 110 may store one or more markers and one or more objects corresponding to each of the markers. Each marker may be classified or divided into multiple regions. The memory unit 110 may store control information of each part of the object to be mapped to each corresponding region of the marker using one-to-one mapping. A marker may be a patterned image included in a real-world view. The marker may have a pattern to be recognized by a computer using a computer vision technology.

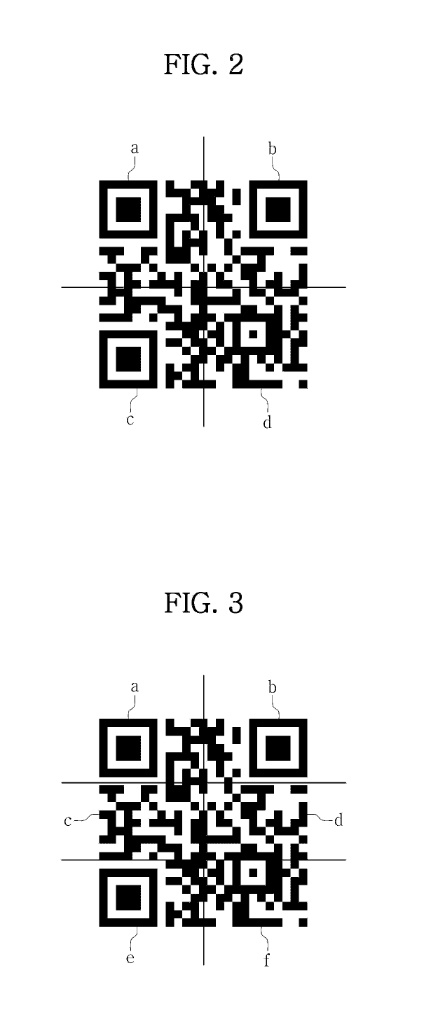

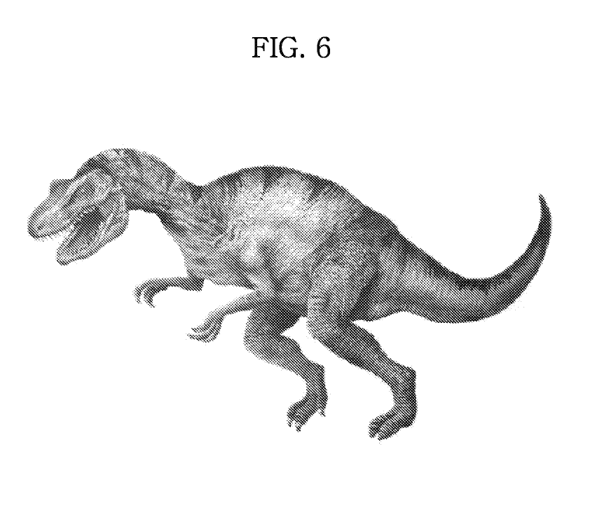

FIG. 2 is a diagram illustrating a marker having four divided regions according to an exemplary embodiment of the present invention. FIG. 5 and FIG. 6 are diagrams illustrating objects associated with AR makers according to an exemplary embodiment of the present invention.

Referring to FIG. 2, the marker has four divided regions, region a, region b, region c, and region d, (a, b, c, and d). Each of the four divided regions may be selected by a user. More than two regions may be selected simultaneously. In an example, an object corresponding to a marker divided into four regions may be an apple illustrated in FIG. 5. Referring to Table 1, control information of each part of the object is mapped to the corresponding region using one-to-one mapping and may be stored in the memory unit 110.

The marker may have two dimensional barcode data as shown in FIG. 2. The marker may be divided into multiple regions based on the two dimensional barcode data. The multiple regions may be recognized by recognizing locations of the vertices of the marker, for example, four vertices of the marker if the marker is a rectangle.

TABLE 1

| Divided region | Control information of each part of object |
|---|---|
| d | Lower right—Delete |
| b | Upper right—Delete |
| c | Lower left—Delete |
| a | Upper left—Delete |

FIG. 3 is a diagram illustrating a marker having six divided regions according to an exemplary embodiment of the present invention.

The marker has six divided regions, a, b, c, d, e, and f. Each of the six divided regions may be selected by a user. More than two regions may be selected simultaneously. In an example, if an object corresponding to a marker divided into six regions may be a dinosaur illustrated in FIG. 6. Referring to Table 2, control information of each part of the object is mapped to the corresponding region using one-to-one mapping and may be stored in the memory unit 110. For example, head, tail, right forelimb, left forelimb, right hindlimb, and left hindlimb may be the six parts of the object, the dinosaur, each corresponding to one of the six regions of the marker.

TABLE 2

| Divided region | Control information of each part of object |
|---|---|
| a | Head—Bow |
| b | Tail—Lift |
| c | Right forelimb—Lower |
| d | Left forelimb—Lower |
| e | Right hindlimb—Lift |
| f | Left hindlimb—Lift |

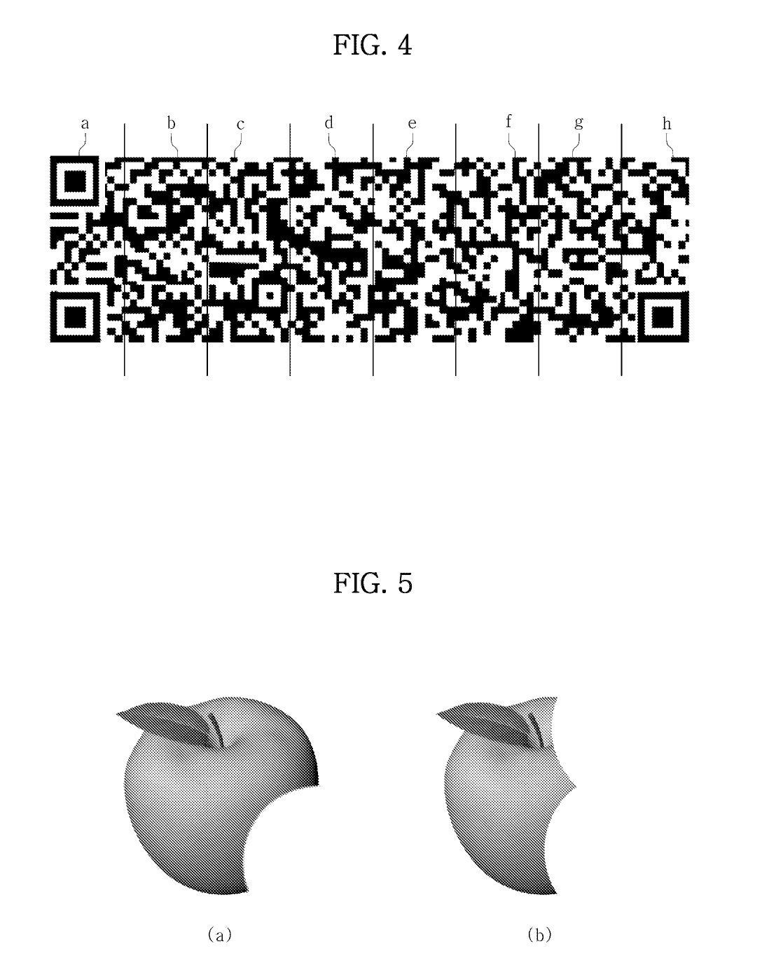

FIG. 4 is a diagram illustrating a marker having eight divided regions according to an exemplary embodiment of the present invention.

The marker has eight divided regions, a, b, c, d, e, f, g, and h. Each of the eight divided regions may be selected by a user. More than two regions may be selected simultaneously. In an example, an object corresponding to a marker divided into eight regions may be rainbow-colored piano keys. Referring to Table 3, control information of each part of the object is mapped to the corresponding region using one-to-one mapping and may be stored in the memory unit 110.

[Table 3]

TABLE 3

| Divided region | Control information of each part of object |
|---|---|
| a | Red key—Do (Low octave) |
| b | Orange key—Re |
| c | Yellow key—Mi |
| d | Green key—Fa |
| e | Blue key—So |
| f | Indigo key—La |
| g | Violet key—Ti |
| h | Black key—Do (High octave) |

The camera unit 120 may capture a real-world view (“real-world image”) including the markers, some of which may be divided into multiple regions.

The first marker recognition unit 130 recognizes the marker captured by the camera unit 120.

The second marker recognition unit 140 determines whether a marker is divided into multiple regions, and recognizes the number of the multiple regions and each location of the multiple regions. The second marker recognition unit 140 recognizes whether a region is selected from among the multiple regions of the marker.

If a portion of a region among the multiple regions of the marker is covered or touched by a user, the second marker recognition unit 140 determines that the region is selected by the user. In an example, the user may cover a portion of a region of the marker using a finger or a physical object. The user may cover a portion of a region of the marker by touching the portion of the display unit 180 which displays the corresponding portion of the region of the marker.

For example, if a user covers a portion of the region b of the marker divided into the four regions as shown in FIG. 2, the second marker recognition unit 140 recognizes that the region b is selected by the user.

Meanwhile, an object selection unit 150 retrieves an object corresponding to the marker recognized by the first marker recognition unit 130 from the memory unit 110, and transmits the object to an image processing unit 170. If a region selected by the user is recognized by the second marker recognition unit 140, the object selection unit 150 retrieves control information regarding a particular part of the object mapped to the region from the memory unit 110, and transmits the control information to an object control unit 160.

The object control unit 160 controls the particular part of the object based on the control information transmitted from the object selection unit 150.

The object control unit 160 may delete the particular part of the corresponding object based on the control information regarding the particular part of the object.

For example, if the region d of the marker in FIG. 2 is selected by a user, the object selection unit 150 retrieves control information regarding the particular part of the object mapped to the region d (for example, Lower right—Delete) from the memory unit 110 and transmits the control information to the object control unit 160. Here, the ‘Lower right’ part is the particular part of the object which is mapped to the region d, and the ‘delete’ is control information regarding the ‘Lower right’ part of the object. The object control unit 160 may retrieve an apple-shaped object of which the lower right portion is deleted as shown in FIG. 5(a) from the memory unit 110 based on corresponding control information, and may transmit the apple-shaped object to the image processing unit 170.

If more than one region is selected by the user, for example, if the region b and region d are simultaneously or sequentially selected, an apple-shaped object of which both upper right and lower right portions are deleted as shown in FIG. 5(b) may be retrieved, and transmitted to the image processing unit 170.

In addition, the object control unit 160 may change a motion of the particular part of the corresponding object based on the control information regarding the particular part of the object.

For example, if the region b of the marker divided into the six regions as shown in FIG. 3 is selected by the user, the object selection unit 150 retrieves control information regarding a particular part of the object mapped to the region b (for example, Tail—Lift) from the memory unit 110 and transmits the control information to the object control unit 160. In an example, the ‘Tail’ is the particular part of the object and the ‘Lift’ is control information regarding the particular part of the object. The object control unit 160 may retrieve a dinosaur-shaped object of which the tail is lifted as shown in FIG. 6 from the memory unit 110 based on the corresponding control information and transmits the dinosaur-shaped object to the image processing unit 170.

In addition, the object control unit 160 may convert audio data corresponding to a particular part of an object based on control information regarding the particular part of the object into an audio signal in connection with an audio processing unit (not shown), and may output the audio signal.

For example, if the region c of a marker divided into eight regions as shown in FIG. 4 is selected by a user, the object selection unit 150 may retrieve control information regarding a particular part of an object mapped to the region c (for example, Yellow key—Mi) from the memory unit 110, and transmits the control information to the object control unit 160. The object control unit 160 may convert audio data corresponding to “mi” sound into an audio signal in connection with the audio processing unit (not shown) based on the control information, and may output the audio signal.

The yellow key corresponding to the region c may disappear, or may be displayed as being pressed. In addition, if multiple regions are selected by the user, audio data corresponding to the multiple regions may be converted into audio signals, and the audio signals may be outputted simultaneously, such as to produce a three-tone chord audio signal.

Meanwhile, the image processing unit 170 may synthesize the object of which the particular part is controlled by the object control unit 160 with the real-world view, and display the synthesized view on the display unit 180.

A direction information acquisition unit 190 acquires direction information regarding an image capturing direction of the terminal 100 using a direction sensor such as a geomagnetic sensor, and an electronic compass, and transmits the direction information to the object selection unit 150.

The object selection unit 150 converts the object retrieved from the memory unit 110 to a converted object based on the direction information transmitted from the direction information acquisition unit 190, and transmits the converted object to the image processing unit 170. The converted object may be a figure seen from the image capturing direction of the terminal 100.

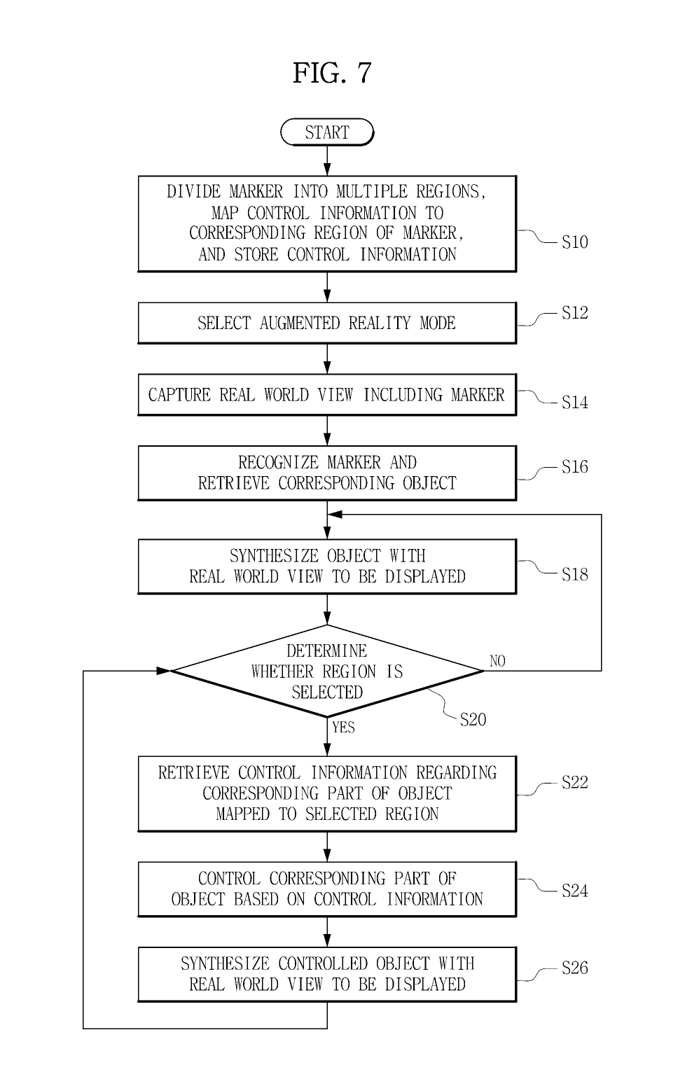

FIG. 7 is a flowchart illustrating a method for providing augmented reality using multiple regions of a marker according to an exemplary embodiment of the present invention.

The method may be performed by a terminal capable of augmented reality service. A marker and an object corresponding to the marker may be stored in the terminal for providing augmented reality. In operation S10, the marker may be divided into multiple regions. Control information regarding each part of an object corresponding to the marker may be mapped to corresponding region of the marker using one-to-one mapping and may be stored in the terminal.

In operation S12, an augmented reality mode may be selected to provide an augmented reality service. In operation S14, a real-world view including a marker having multiple regions may be captured in the augmented reality mode.

In operation S16, if the marker is recognized, an object corresponding to the marker may be retrieved. Then, the object may be synthesized with the real-world view to be displayed as a synthesized view for augmented reality in operation S18.

In operation S20, the terminal may determine whether a region is selected among the multiple regions of the marker.

In the operation S20, if a portion of a region is covered or touched by a user, the terminal may determine that the region is selected by the user.

If it is determined that a region is selected, control information to control a part of the object may be retrieved in operation S22. The part of the object is mapped to the selected region.

In operation S24, the corresponding part of the object may be controlled based on the control information.

In operation S26, the object of which the corresponding part is controlled may be synthesized with a real-world view and may be displayed on the terminal.

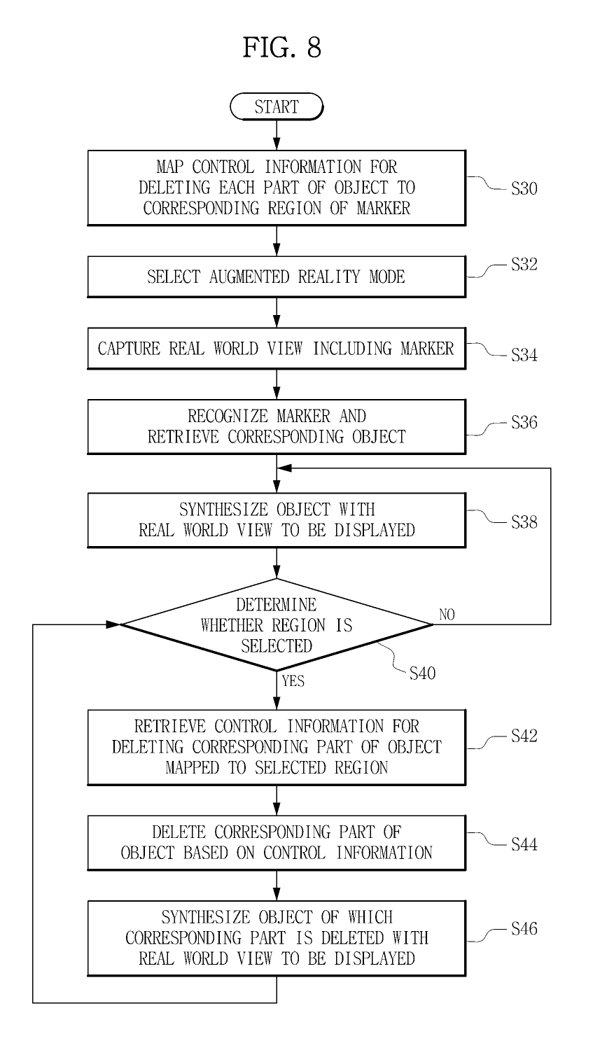

FIG. 8 is a flowchart illustrating a method for providing augmented reality using multiple regions of a marker according to an exemplary embodiment of the present invention.

The method may be performed by a terminal capable of augmented reality service. In operation S30, control information for deleting each part of an object may be mapped to a corresponding region of a marker by one-to-one mapping, and the control information and the mapping information may be stored in the terminal. Thus, if a region of the marker is selected by a user, a corresponding part of the object may be deleted based on the control information and the mapping information. For example, the object may be an apple image and the control information may be control information for deleting a corresponding part of the apple image. If the region d of the marker in FIG. 2 is selected, the lower right part of the apple image may be deleted as shown in FIG. 5 based on corresponding control information. The control information for deleting a part of an object may be referred to as deletion information.

In operation S32, an augmented reality mode may be selected to provide an augmented reality service. In operation S34, a real-world view including a marker having multiple regions may be captured in the augmented reality mode.

In operation S36, if the marker is recognized, an object corresponding to the marker may be retrieved. In operation S38, the object may be synthesized with the real-world view to be displayed as a synthesized image for augmented reality.

In operation S40, the terminal may determine whether a region is selected among the multiple regions of the marker. If it is determined that a region is selected, control information for deleting corresponding part of the object mapped to the region may be retrieved in operation S42. The control information for deleting corresponding part of the object is mapped to the region of the marker. For example, if the region d is selected, control information for deleting lower right part of an apple image may be retrieved. The control information for deleting lower right part of an apple image is mapped to the region d.

In operation S44, the corresponding part of the object mapped to the region may be deleted based on the control information. For example, the lower right part of the apple image may be deleted based on the control information as shown in FIG. 5. In operation S46, the object of which the corresponding part is deleted may be synthesized with a real-world view and the synthesized view may be displayed on the terminal.

This FIG. 8 has been described for an exemplary embodiment of deleting a portion of an object based on a selected region of a marker. However, a different operation could result from the selection of a region. For example, the exemplary embodiment could include changing a characteristic of an object based on a selected region of a marker. The characteristic could include a size, a color, an orientation, an object image resolution, or other displayed characteristic.

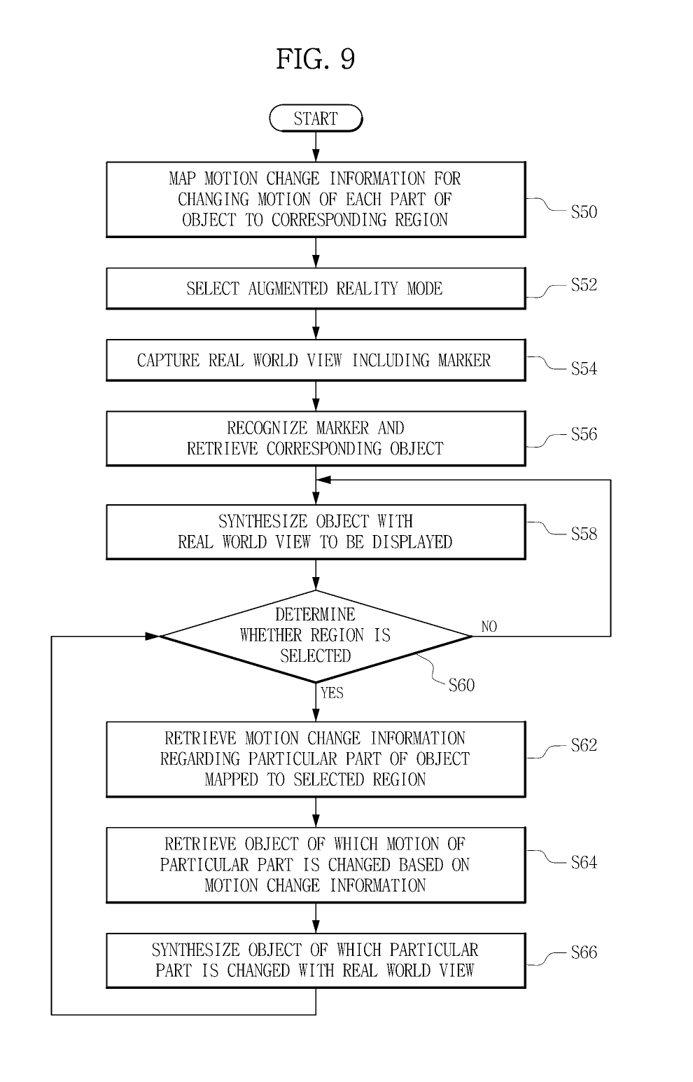

FIG. 9 is a flowchart illustrating a method for providing augmented reality using multiple regions of a marker according to an exemplary embodiment of the present invention.

The method may be performed by a terminal capable of augmented reality service. In operation S50, motion change information for changing a motion of each part of an object may be mapped to corresponding region of a marker by one-to-one mapping, and the motion change information and the mapping information may be stored in the terminal. The object may include an object capable of changing a motion such as a dinosaur, a robot, a doll, and an animal.

In operation S52, an augmented reality mode may be selected to provide an augmented reality service. In operation S54, a real-world view including a marker having multiple regions may be captured in the augmented reality mode.

If the marker is captured through the terminal in the operation S54, the marker may be recognized and the object corresponding to the marker may be retrieved in operation S56. The object may be synthesized with the real-world view and may be displayed on the terminal in operation S58. The object may include a dinosaur image as shown in FIG. 6.

In operation S60, the terminal may determine whether a region is selected among the multiple regions of the marker. If it is determined that a region is selected, the motion change information regarding a particular part of the object mapped to the region may be retrieved in operation S62. For example, the object may be a dinosaur image and the dinosaur image may be divided into six parts, head, tail, and each of four legs. The motion change information may include a motion such as lifting and lowering of a part of the dinosaur image. If the region b of the marker is selected, the tail of the dinosaur image may be lifted based on the motion change information mapped to the region b.

In operation 64, an object of which a motion of a particular part is changed may be retrieved based on the motion change information. The particular part of the object is mapped to the selected region. For example, the tail of the dinosaur image may be changed to a lifted-tail image of the dinosaur. In operation S66, the object of which the corresponding part is changed may be synthesized with a real-world view and the synthesized view may be displayed on the terminal.

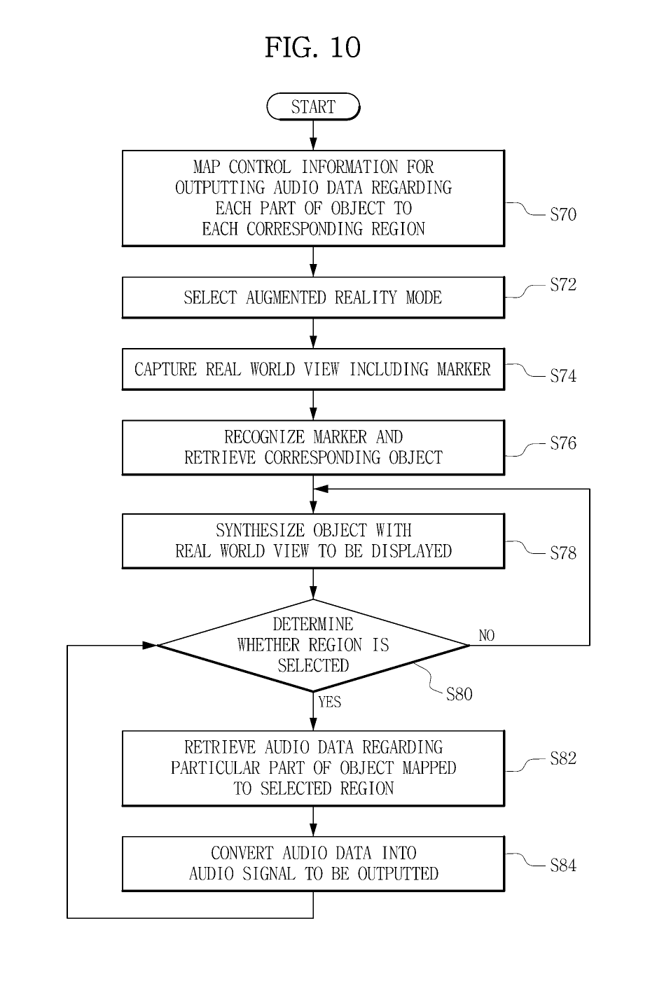

FIG. 10 is a flowchart illustrating a method for providing augmented reality using multiple regions of a marker according to an exemplary embodiment of the present invention.

The method may be performed by a terminal capable of augmented reality service. In operation S70, control information for outputting audio data regarding each part of an object may be mapped to each corresponding region of a marker by one-to-one mapping and the control information and the mapping information may be stored. For example, the object may include a musical instrument image such as a piano, an ocarina, a guitar, a violin, a drum, and a gayageum.

In operation S72, an augmented reality mode may be selected to provide an augmented reality service. In operation S74, a real-world view including a marker having multiple regions may be captured in the augmented reality mode.

In operation S76, if the marker is recognized, an object corresponding to the marker may be retrieved. In operation S78, the object may be synthesized with the real-world view to be displayed as a synthesized image for augmented reality. For example, the retrieved object may be an image of piano keys.

In operation S80, the terminal may determine whether a region is selected among the multiple regions of the marker. If it is determined that a region is selected, audio data regarding a particular part of the object mapped to the region may be retrieved in operation S82. Also, the control information mapped to the selected region may be retrieved. The control information may control a part of an object and the part of the object may be mapped to the selected region. For example, if the region c in FIG. 4 is selected, the control information to control a part of the object may be retrieved. The part of the object, a yellow key of the piano key image representing ‘Mi’, may be mapped to region c.

In operation S84, an audio data corresponding to the part of the object may be converted into an audio signal based on the control information and the audio signal may be outputted. Further, the corresponding part of the object mapped to the region may be changed based on the control information. For example, the yellow key of the piano key image may be changed to a pressed key image. Then, the object of which the corresponding part is changed may be synthesized with a real-world view and the synthesized view may be displayed on the terminal.

Hereinafter, examples are provided of objects controlled by multiple regions of corresponding markers. In an example, a marker may be divided into multiple regions, and each of the multiple regions may be mapped to each part of a doll image. For example, each of the multiple regions may be mapped to each part of the doll image such as head, arms, hands, legs, feet, upper body, lower body, and the like. Control information to control each part of the doll image may also be mapped to each of the multiple region. The control information may be used to change clothes image of each part of the doll. If the region to which the head is mapped is selected, hair style of the head may be changed or a hat image may be added on the head. If the region to which the feet are mapped is selected, shoes of the doll may be changed. In this manner, a doll clothes changing service may be provided.

In another example, transformation information to control each part of a robot may be mapped to each of multiple regions of a marker and may be stored. For example, the robot may be divided into head, hand, foot, upper body, lower body, and the like. If the region to which the head is mapped is selected, a helmet image of the robot may be changed. If the region to which the hand is mapped, the weapon held by the hand may be changed. In this manner, a transformation robot service may be provided.

According to exemplary embodiments of the present disclosure, a user may control each part of an object using a marker having multiple regions. Control information for each part of the object may be mapped to each of the multiple regions, thus the user may have various control functions in an augmented reality service.

While the exemplary embodiments have been shown and described, it will be understood by those skilled in the art that various changes in form and details may be made thereto without departing from the spirit and scope of this disclosure as defined by the appended claims and their equivalents.

In addition, many modifications can be made to adapt a particular situation or material to the teachings of this disclosure without departing from the essential scope thereof. Therefore, it is intended that this disclosure not be limited to the particular exemplary embodiments disclosed as the best mode contemplated for carrying out this disclosure, but that this disclosure will include all embodiments falling within the scope of the appended claims and their equivalents.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A terminal to provide augmented reality, comprising:
a memory unit to store a marker comprising a first region and a second region, an object corresponding to the marker, and first control information mapped to a first part of the object;
a camera unit to capture a real world view comprising the marker;
a first marker recognition unit to recognize the marker;
a second marker recognition unit to recognize the first region;
an object selection unit to retrieve the object and the first control information;
an object control unit to control the first part of the object based on the first control information if the first region is selected;
an image processing unit to synthesize the object with the real-world view into a synthesized view; and
a display unit to display the synthesized view.

2. The terminal of claim 1, wherein the object control unit deletes the first part of the object based on the first control information.

3. The terminal of claim 1, wherein the object control unit changes a motion of the first part of the object based on the first control information.

4. The terminal of claim 1, wherein the object control unit converts audio data corresponding to the first part of the object into an audio signal based on the first control information, and outputs the audio signal.

5. The terminal of claim 1, wherein the first control information or the first part of the object are mapped to the first region,
the object control unit obtains a modified object comprising a modified first part of the object,
the image processing unit synthesizes the modified object with the real-world view into a first synthesized view, and
the display unit displays the first synthesized view.

6. The terminal of claim 1, wherein the memory unit stores second control information to control a second part of the object,
the second marker recognition unit recognizes the second region,
the object selection unit retrieves the second control information,
the object control unit controls the second part of the object based on the second control information, and
the second control information is mapped to the second region.

7. A method for providing augmented reality, comprising:
storing a marker comprising a first region, an object corresponding to the marker, and first control information mapped to a first part of the object;
determining whether the first region is selected;
retrieving the first control information;
controlling the first part of the object based on the first control information;
synthesizing the object with the real-world view into a synthesized view; and
displaying the synthesized view.

8. The method of claim 7, further comprising:
capturing a real-world view including the marker;
recognizing the marker from the real-world view;
retrieving the object corresponding to the marker;
modifying the first part of the object into a modified object based on the first control information; and
synthesizing the modified object with the real-world view.

9. The method of claim 7, further comprising:
determining whether a portion of the first region is covered,
wherein the first region is selected if it is determined that the portion of the first region is covered.

10. The method of claim 7, wherein controlling the first part of the object comprises deleting the first part of the object.

11. The method of claim 7, wherein controlling the first part of the object comprises changing a motion of the first part of the object.

12. The method of claim 7, wherein controlling the first part of the object comprises converting audio data corresponding to the first part of the object into an audio signal.

13. A terminal to provide augmented reality, comprising:
a camera unit to capture a real-world view having a marker comprising a first region and a second region;
a memory unit to store an object corresponding to the marker, first control information mapped to a first part of the object, and second control information mapped to a second part of the object;
an object control unit to control the first part of the object based on the first control information if the first region is selected, and to control the second part of the object based on the second control information if the second region is selected;
an image processing unit to synthesize the object with the real-world view into a synthesized view; and
a display unit to display the synthesized view.

14. The terminal of claim 13, further comprising:
a first marker recognition unit to recognize the marker;
a second marker recognition unit to recognize the first region and the second region;
an object selection unit to retrieve the object, the first control information, and the second control information from the memory unit; and
a direction information acquisition unit to acquire an image capturing direction.

15. The terminal of claim 13, wherein the object control unit deletes the first part of the object based on the first control information.

16. The terminal of claim 13, wherein the object control unit changes a motion of the first part of the object based on the first control information.

17. The terminal of claim 13, wherein the object control unit converts audio data corresponding to the first part of the object into an audio signal based on the first control information, and outputs the audio signal.

18. The terminal of claim 13, wherein the first control information or the first part of the object are mapped to the first region,
the object control unit obtains a modified object comprising a modified first part of the object,
the image processing unit synthesizes the modified object with the real-world view into a first synthesized view, and
the display unit displays the first synthesized view.
